(19) United States
(12) Patent Application Publication
(10) Pub. No.: US 2014/0358658 A1
(43) Pub. Date: Dec. 4, 2014

(54) METHOD, SYSTEM AND SOFTWARE PRODUCT FOR PROVIDING DISCOUNTED PRICING

(71) Applicant: 4IMPRINT, INC, Oshkosh, WI (US)

(72) Inventors: Kevin Lyons-Tarr, Neenah, WI (US); Richard J. Morton, Oshkosh, WI (US)

(21) Appl. No.: 14/294,475

(22) Filed: Jun. 3, 2014

Related U.S. Application Data
(60) Provisional application No. 61/830,818, filed on Jun. 4, 2013.

(51) Int. Cl. G06Q 30/02; G06Q 50/18

(52) U.S. Cl. CPC G06Q 30/0222; G06Q 50/188
USPC 705/14.23

(57) ABSTRACT

A computer implemented method and a computer program product allow a retailer to provide a discounted price for a product by electronically offering a product for sale to a buyer; using a computer to display the product to the buyer on a user interface, the display comprising a product detail page; displaying on the product detail page the original full price of the product, the discounted outlet price of the product and the percentage off amount for that product; displaying a screen indicia to the buyer; inviting the buyer to use the screen indicia to open a virtual negotiation panel on the display; inviting the buyer to enter a quantity of products that the buyer wants to buy and the per product price that the buyer is willing to pay; and using the computer to calculate the lowest price per product that the retailer will accept for the product.

This Application claims the benefit of U.S. Provisional Application No. 61/830,818, filed Jun. 4, 2013.

### FIELD OF THE INVENTION

This invention relates generally to the marketing and selling of products and services. It also relates generally to web-based (i.e. utilized by means of the virtual community that exists within the “world wide web,” or “www” and accessed via the “internet”) methods and systems for acquiring, storing, processing, retrieving and displaying information and data via a buyer or customer interface, such as a monitor screen or touch screen.

More specifically, this invention relates to a method, software product and system for use by sellers to provide buyers with an opportunity to negotiate discounted pricing for products, such as those products that are of limited availability, overstock, “end of line” or clearance products. It also relates to a method, software product and system that allows such products to be sold more quickly while still allowing the seller to realize a successful price margin for such products while also affording the customer with a price savings on its purchase.

### BACKGROUND OF THE INVENTION

Many products and services are purchased today via the internet. With respect to products sold on such web-based platforms, in particular, many of them are offered to a retailer by a supplier and end up being limited availability products, overstock products, end of line or clearance products. That is, these are typically products that have a limited inventory and, once that inventory is depleted, the products are gone and will not be re-stocked.

Additionally, particular products may be offered exclusively by a single supplier to multiple vendors or retailers. When initially offered for sale, the sale of such products may be robust. As time goes by, however, stock may remain for a period of time longer than desired by the retailer. In such situations, the retailer may reduce the price of the product with the hope that the stock eventually sells out.

In the view of these inventors, what is needed as a solution to each of the situations described above, which would be an improved method and system for providing discounted pricing for products, such products being offered to a retailer by a suppler and such products being limited availability products, overstock products, end-of-line or clearance products that are sold to a customer via a web-based platform. Providing such a pricing solution would then result in the supplier being able to more quickly dispose of this type of inventory while also providing an incentive for the purchaser to buy such products.

### SUMMARY OF THE INVENTION

In accordance with the foregoing, these inventors have devised a web-based functionality that allows sellers to effectively offer “good deals” to customers on such limited availability products, overstock products, end-of-line products and clearance products that engages the customer in a fun and unique way as part of the customer's buying process.

This functionality can begin by placing the products that are to be sold on line within some type of visual display, which is typically a product detail page that is displayed to a buyer via an interface. Preliminarily, the product could be offered for sale and sold using that certain product sale “functionality” of the type that is disclosed and claimed in U.S. Pat. No. 7,979,318, which is referred to herein as the “GLIDE™ functionality.” It is to be noted, however, that the functionality of the present invention is not required to incorporate the GLIDE™ functionality and the present invention is not so limited.

After a pre-determined period of time under the GLIDE™ functionality, such as for a pre-determined numbers of days or weeks for example, the display would then be changed to a “STEAL A DEAL™ functionality.” That is, the GLIDE™ functionality, together with the GLIDE™ slider, will no longer be displayed. In its place, the STEAL A DEAL™ functionality would include, in the website display, the following: (i) the original full price for the product; (ii) the discounted outlet price (the term “outlet” meaning the price that is placed on limited availability products, overstock products, end-of-line products and clearance products, among other products that are offered for sale at a discounted price); and (iii) the percentage off amount, all of which is preferably displayed adjacent to or in close proximity to the product on the display screen of the retailer.

It should be noted here that the products being sold may be provided to a retailer by a supplier and then to a customer. The functionality of the present invention allows the retailer to request that the supplier move to the new platform, as is disclosed herein. Accordingly, the present invention may provide an interface for each of the supplier, the retailer and the customer.

If the customer is interested in ordering the product, the customer will then be invited to “click” a STEAL A DEAL™ virtual button, which would be displayed immediately below the pricing on the product detail page, or anywhere within the product detail page that is displayed. By use of the word “click” in this application, the inventors note that this functionality can be accomplished via a virtual touch button (also called a “soft” button) that is displayed on a touch screen device, a mouse or a specific key on a keyboard, such as an ENTER button, when an indicator is “hovered” over the STEAL A DEAL™ virtual button that would be displayed on the customer interface. A soft button or a virtual button as presented in this application may be identified as an “indicia” or as a “screen indicia” within the body of the detailed description and within the claims that follow. The physical act of using tactile “touching” of the soft button or the “clicking” of the virtual button may be identified as “actuation” of such button, or indicia, within the body of the detailed description and within the claims that follow.

If the customer clicks on the STEAL A DEAL™ button, a panel will appear, or “pop up.” This is a “negotiation” panel that will ask the customer to enter how many items the customer would like to buy and invite the customer to enter the price per unit that the customer would be willing to pay.

An algorithm is then used in accordance with the present invention which ultimately calculates the lowest price per unit that the retailer will accept for the product. If the price that the customer has suggested is equal to or above the lowest price setting, then the customer's price will be accepted. If the price that the customer has suggested is below the lowest price setting, then the negotiation panel will suggest a counter offer. At this point, the customer can choose to either accept the deal, or suggest another offer that would be greater than the customer's original offer. The functionality of the present invention will allow the customer to make a pre-determined number of counter offers, which number is pre-programmed into the computer algorithm. However, the number of counter offers is held as a variable that the seller can control.

The foregoing and other features of the method and system of the present invention will become apparent from the detailed description that follows.

### DETAILED DESCRIPTION

As a prefatory statement, it is to be understood that the method and system of the present invention assumes usage of a specific computer program that is used by the seller and the buyer within an electronic commerce (or “e-commerce”) environment that comprises certain system building block “components.” Those components are data structures, data processors and interfaces, and each component is a functional element thereof.

The data structures are places to organize and store data.

The data processors are used to manipulate data by performing processes or applying algorithms to the data.

The interfaces connect the data structures and the data processors to the outside world, or to other data structures and data processors, including the virtual community that exists within the “world wide web” or “www.” The interface for the customer would be the customer's screen display, be it a desk top monitor, a lap top screen or the screen of a portable computer device with or without touch screen functionality.

The program of the present invention includes source code, which is a list of instructions, written in a selected computer language and then converted into computer machine language, which language the computer uses to build the software “machine” described by the instructions. The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention.

Finally, it is to be understood that the pages on the website that uses the method and system of the present invention can be somewhat similar to pages found on other websites, including those offering products or services for sale in various quantities in particular. As previously mentioned, the functionality of the present invention can begin by placing the products that are to be sold on line within some type of visual display, which is typically a product detail page that is displayed to a customer via a user interface, also as described above. It is also to be mentioned here that products being sold in accordance with the present invention may be provided to a retailer by a supplier and then to a customer. The functionality of the present invention allows the retailer to request that the supplier move to the new platform, as disclosed herein. In short, the present invention may provide an interface for each of the supplier, the retailer and the customer.

In a preferred embodiment, the product would be first offered for sale and sold using the GLIDE™ functionality, for example. It is to be understood that the GLIDE™ functionality is not necessary for enablement of the present invention and these inventors present that functionality as one with which the present invention is fully compatible, other base functionalities being included within the scope of the present invention. However, the GLIDE™ functionality is not required for implementation of the functionality of the present invention. That is, the present invention is not limited to it being used with the GLIDE™ functionality only. Indeed, the present invention can be used without the GLIDE™ functionality and such use would be another preferred embodiment of the present invention.

Assuming that the GLIDE™ functionality is used, and after a pre-determined period of time of the product being offered for sale under the GLIDE™ functionality, or such other suitable functionality, the time period being a pre-determined number of days or weeks, the display associated with the base functionality is changed to a “STEAL A DEAL™ functionality.” The GLIDE™ or other base functionality, together with the GLIDE™ slider in the case of the GLIDE™ functionality, is no longer displayed. In its place, the STEAL A DEAL™ functionality would include, in the customer interface or website display, (i) the original full price for the product, (ii) the discounted outlet price, and (iii) the percentage off amount, as previously described in the Summary of the Invention section of this original disclosure. Again, the retailer may request that the supplier move to the new platform during this step.

If the customer is interested in ordering the product, the customer will then be invited to “click” a STEAL A DEAL™ button, which would be displayed immediately below the pricing on the product detail page. Again, use of the word “click” herein means that the functionality can be initiated via a virtual touch button displayed on a touch screen device, a mouse or a specific key on a keyboard, such as an ENTER button, when an indicator is “hovered” over the STEAL A DEAL™ virtual button that would be displayed on the customer interface.

If the customer clicks on the STEAL A DEAL™ button, a panel will pop up. This is a negotiation panel that will ask the customer to enter how many items the customer would like to buy and invite the customer to enter the price per unit that the customer would be willing to pay.

An algorithm is then used in accordance with the present invention which ultimately calculates the lowest price per unit that the retailer will accept for the product. If the price that the customer has suggested is equal to or above the lowest price setting, then the customer's price will be accepted. If the price that the customer has suggested is below the lowest price setting, then the negotiation panel will suggest a counter offer. At this point, the customer can choose to either accept the deal, or suggest another offer that would be greater than the customer's original offer.

The functionality of the present invention will allow the customer to make a pre-determined number of counter offers. When the maximum number of counter offers has been reached, the last counter offer is “locked” against that product for that customer for a specified period of time, most probably 24 hours. Until this lock is released, no further negotiation can be made by that particular customer for that particular product. The customer can choose to pay the “locked” price, negotiate on a different product or re-visit the website when the lock has passed and try to STEAL A DEAL™ again. Because these products are end of line products, there is a risk to the customer in waiting for the lock period to end. Specifically, the product may have sold out to another customer in the meanwhile.

The primary aspects of the present invention and its algorithm are how the minimum acceptable price for an item is calculated and how a counteroffer amount is calculated. The algorithm that works out the minimum acceptable selling price has additional features to ensure that the seller will always make a minimum dollar amount of profit per order. It also makes it difficult for customers to determine exactly how the minimum price per item is calculated. The algorithm also ensures that it is not random on a per customer basis. That is, the minimum prices and counter offers are repeatable by different customers as long as they enter the same quantity and prices, in the same order, in their negotiations. This rewards sensible price negotiations. That is, if the customer suggests a price way below the minimum acceptable price, the system will counter offer with a price much higher than the minimum price. As the customer gets closer to the minimum prices, the system of the present invention counters with prices that are closer to that price. Lastly, the algorithm automatically lowers the minimum acceptable price of the items based on the age of the items. That is, the longer an item has been available for sale on the seller's website, the better the potential deal is for the customer.

Referring now to a specific embodiment of the present invention, the first step is to calculate the “minimum acceptable price” per product unit, or “MAP” as will be used hereinafter.

The second step is working out the pricing of a counteroffer once the customer has entered the price that it wishes to bid. In order to prevent a reverse engineering of the algorithm, an additional step is included, which is referred to “raising the floor.” Further, the program of the present invention looks at how close the last offer is to what the seller would accept. If that offer is within a certain range, which can be a fixed dollar amount or calculated as a percentage, the seller will accept that offer.

### Calculating the Seller's MAP

The program of the present invention holds a “Base Earnings per Order” (or “BEPO”) dollar amount in a configuration file. The BEPO is the absolute minimum amount per order that the program will accept. This amount is constant, no matter what the product is or what number of units of product are requested by the customer.

The program holds a second figure in a configuration file, which is the “Percent Off Remaining Margin” (or “PRM”). The PRM describes the amount of discount the retailer is willing to accept off the margin that would normally be made if the item units were sold at regular pricing under the GLIDE™ functionality mentioned above. This percentage is then calculated against the profit of the order after the BEPO has been removed from that figure.

By way of specific example, if the per unit cost to the retailer is $0.13, the selling price under the GLIDE™ functionality is $0.39, and the minimum purchase quantity is 300, the order would ordinarily cost the customer $117. $78 of that amount would be profit for the retailer. This represents a total margin of 66.67%.

Using the program of the present invention, the BEPO could be set to $50 and the PRM to 50%, the figures become: $103 cost to the customer and $64 profit for the retailer. This leaves a new total margin on the order of 62.14%. This $103 order cost for 300 units amounts to $0.34 for each unit. This is the “minimum acceptable price,” or MAP, for this particular item.

As this particular product ages on the retailer's website, which means that the product has remained on the website for a pre-programmed amount of time, the PRM figure is automatically increased, which in turn decreases the MAP. Thus, products that have been on the site longer will provide better pricing deals for the buyer or customer to negotiate.

If the PRM amount is 80%, the same sample product above looks like this: setting the BEPO to $50 and the PRM to 80%=$94.60 order cost, leaving a $55.60 profit and 58.77% total margin on the order. With this $94.60 order cost, for 300 units, MAP is $0.32.

### Customer Counter Offers

The second part of the program is working out the dollar amount counter offer once the buyer or customer has entered the price it wants to bid. Here, the percentage below MAP that the customer has bid is identified. The counter offer is calculated by identifying the percentage below MAP that the customer has bid. The counter offer is then calculated by moving up from the MAP to the original GLIDE™ selling price by the same percentage. This ensures that if the customer submits a low ball amount, the counter offer is higher than if the customer offers a price closer to the MAP.

In the example above, the MAP is $0.34. If the customer bids $0.10, that amount represents approximately a 70% deviation from the MAP amount. That is, a $0.10 bid is 70% along a line from the $0.34 MAP down to $0.00. The counter offer then would move 70% up the line from the $0.34 MAP up to the original GLIDE™ price of $0.39, leading to a counter offer of $0.38 each. If the customer had bid $0.20 instead, this would be 41% below MAP. The counter offer thus becomes $0.36 for each unit.

### Raising the Floor

In order to preserve the integrity of the details of implementation of the present invention, an additional step is used, which is called “Raising the Floor.” The way this works is that, if the customer has bid more than X% below MAP, the seller essentially raises the MAP for the next round of bidding. What this means is that, if the customer submits a very low ball bid the first time around, the counter offers will go up only very slightly the next time a counter offer is made.

In the example above where the customer bid $0.20 per item, the customer was 41% below MAP, so the program of the present invention “raises the floor” by 8% with the next go around. That is 41 divided by 10 and multiplied by 2 equals 8% for items under $1.00. For items over $1.00, the program of the present invention calculates this as 41 divided by 10, which equals 4%. This means that the counter offer will be slightly higher the next time around.

Some additional features to note about the “Raising the Floor” functionality is that the floor raising is cumulative, so if the floor is raised 14% after the first bid and it needs to be raised by another 5% after the second bid, it will be raised against the floor that is already 14% above MAP, not just raising the MAP by 5%. Next, if the customers bid is within 10% of MAP, then the program does not raise the floor. Additionally, if the floor had already been raised during an earlier bid, then the current percentage that the floor raise is at is halved. Thus a 14% raise becomes a 7% raise for the next go around.

It is further to be noted that the raised floor amount is used purely to help calculate the counter offer and obfuscate the algorithm. That is, it does not mean that the raised floor becomes the new MAP. So, if the original MAP amount was $0.38 but the raised floor amount after a couple of bids is $0.42, if the customer bids $0.38, the seller will accept it.

As previously alluded to, the program of the present invention looks at how close the last offer is to what the seller would accept. If that offer is within a certain range, which can be a fixed dollar amount or calculated as a percentage, the seller will accept that offer. This functionality has been named the “Flex Value” functionality which keeps the seller from declining a final reasonable offer, as opposed to rejecting an offer that is within a few cents of the asking price.

In accordance with the foregoing, it will be seen that there has been provided a new and useful method, program and system that provides discounted pricing for products that are limited availability products, overstock products, end-of-line or clearance products that are sold via a web-based platform. Providing such a pricing solution results in the supplier being able to more quickly dispose of this type of inventory while also providing a cost-saving incentive for the purchaser to buy such products.

The details of the invention having been disclosed in accordance with the foregoing, we claim:

1. A computer implemented method for providing a retailer's discounted price for a product comprising the steps of:
electronically offering a product for sale to a buyer;
using the computer to display the product to the buyer on a user interface, the display comprising a product detail page;
displaying on the product detail page the original full price of the product, the discounted outlet price of the product and the percentage off amount for that product;
displaying a screen indicia to the buyer;
inviting the buyer to use the screen indicia to open a virtual negotiation panel on the display;
inviting the buyer to enter a quantity of products that the buyer wants to buy and the per product price that the buyer is willing to pay; and
using the computer to calculate the lowest price per product that the retailer will accept for the product.

2. The method of claim 1 further comprising the step of accepting the buyer's price if the price that the buyer enters is equal to or above the lowest price setting in the computer.

3. The method of claim 1 further comprising the step of presenting the buyer with a counter offer if the price that the buyer enters is below the lowest price setting in the computer.

4. The method of claim 3 wherein only a pre-programmed number of counter offers can be made to the buyer.

5. The method of claim 4 wherein the pre-programmed number of counter offers is variable and controlled by the retailer.

6. The method of claim 1 wherein the product is supplied to the retailer by a supplier and wherein the method further comprises the step of using the computer to provide an interface to the supplier.

7. The method of claim 1 wherein the lowest price calculation step comprises the steps of:
enabling the computer to calculate the MAP for the product;
enabling the computer to calculate how close the buyer's offer is in relation to the MAP;
enabling the computer to hold a BEPO in a configuration file; and
enabling the computer to hold a PRM in a configuration file.

8. The method of claim 7 further comprising the step of enabling the computer to recalculate an increased PRM figure and a decreased MAP as the product ages on the retailer's website.

9. The method of claim 7 further comprising the step of enabling the computer to identify the percentage below MAP that the buyer has offered.

10. The method of claim 9 further comprising the step of enabling the computer to raise the MAP where the percentage below MAP exceeds a pre-determined amount.

11. The method of claim 10 wherein the raising of the MAP is cumulative.

12. The method of claim 7 further comprising the step of enabling the computer to include a flex value functionality to prevent the seller from declining a final reasonable offer made by the buyer.

13. A computer program product for providing a discounted price for a product, the computer program product being embodied in a non-transitory computer readable medium comprising computer instructions for:
generating a buyer interface, the interface comprising a buyer screen display;
providing a web page that displays a product offered for sale by a retailer on the buyer screen display via the buyer interface;
providing on the screen display the original full price of the product, the discounted outlet price of the product, and the percentage off amount for that product;
providing a screen indicia for the buyer, the screen indicia being used to invite the buyer to open a virtual negotiation panel on the screen display;
allowing the buyer to enter a quantity of products that the buyer wants to buy and the per product price that the buyer is willing to pay;
calculating the MAP for the product;
calculating how close the buyer's entered price in to the MAP;
holding a BEPO in a configuration file; and
holding a PRM in a configuration file.

14. The computer program product of claim 13 further comprising computer instructions for accepting the buyer's price if that price is equal to or above the MAP.

15. The computer program product of claim 13 further comprising computer instructions for presenting the buyer with a counter offer if the buyer's price is below the MAP.

16. The computer program product of claim 15 further comprising computer instructions for limiting the number counter offers that can be made to the buyer.

17. The computer program product of claim 16 further comprising computer instructions for recalculating an increased PRM and a decreased MAP as the product ages.

18. The computer program product of claim 16 further comprising computer instructions for identifying the percentage below MAP that the buyer has offered.

19. The computer program product of claim 18 further comprising computer instructions for raising the MAP where the percentage below MAP exceeds a pre-programmed amount.

20. The computer program product of claim 19 wherein the computer instructions for raising the MAP comprise instructions for allowing a cumulative amount of the MAP.

21. The computer program product of claim 16 further comprising computer instructions for calculating a flex value to prevent the retailer from declining a final reasonable offer made by the buyer.
